(19) United States
(12) Patent Application Publication
(10) Pub. No.: US 2009/0022071 A1
(43) Pub. Date: Jan. 22, 2009

(54) Telecommunication method by a control message

(76) Inventors: Aline Tarrago, Sceaux (FR); Francois Cottin, Paris (FR); Michel Seiler, Neuilly-Sur-Seine (FR); Sylvie Heriard Dubreuil, Paris (FR); Frederic Falleta, Le Kremlin-Bicetre (FR); Guy Caminondo, Rouillon (FR); Cyrille Van Der Voort, Courbevoie (FR); Thierry Sayd, Paris (FR); Aissatou Barry, Paris (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/887,090

(22) PCT Filed: Mar. 22, 2006
(86) PCT No.: PCT/FR2006/050248

§ 371 Date: Sep. 24, 2007

(30) Foreign Application Priority Data
Mar. 22, 2005 (FR) 0502821

(51) Int. Cl. H04L 12/16

(52) U.S. Cl. 370/259

(57) ABSTRACT

A method for communicating messages by at least one control message for at least one predefined set of terminals (10, 21, 22, 31, 32), wherein said method comprises the steps of defining at least one communication device (10), included in said set of terminals (10, 21, 22, 31, 32) and corresponding to at least one subscriber to at least one service platform (100); receiving via said communication device (10) at least one control message, originating from said platform (100), in order to check an execution of at least one application based on at least one script, included in said control message; transmitting via said communication device (10) at least one identifier of said application to be executed to at least one management device (11), associated with said set of terminals (10, 21, 22, 31, 32), based on said script; recognizing said application based on at least one list of applications stored by said management device (11); recognizing at least one of said terminals of said set from at least one list of referenced terminals (10, 21, 22, 31, 32) stored by said management device (11); and checking by said management device (11) the execution of said application for said recognized terminal of said set.

The present invention relates to a system and a method for communication by at least one control message for a predefined set of terminals.

The invention finds a particularly advantageous application in the field of automatic and simplified checking of at least one application from a communication device.

The prior art teaches us means for transmitting a hypertext link in a message, in particular to an electronic mail service, that make it possible to control a browser and access a web page external to the electronic mail service.

However, these known means of control via a link usually have the disadvantage of systematically controlling the same application (for example an Internet browser) for all the received messages and links without taking account of a possible optimization of the application to be controlled or in order to obtain a better quality of service. In addition, the message with said link being received on a given terminal, the control and execution of the application are systematically carried out by the same receiving terminal.

In this sense, it is possible to evoke mail items delivered by post which provide for the transmission of a specific envelope for the response, called a “reply-paid envelope”, which allows a simplified and automatic transmission of a preformatted card for a standard response with an intended recipient that is different from the receiver of the mail. The mechanism of the response is prepared and simplified. It will be noted nevertheless that the intended recipient of the response, although different from the receiver, is imposed and unique, without the possibility of any choice by said receiver.

Also, a technical problem to be resolved by the subject of the present invention is to propose a communication method by at least one control message for at least one predefined set of terminals, which would make it possible to remedy the disadvantages of the existing systems and would allow an automatic and simplified checking of an application on one of the terminals of said predefined set.

The solution to the technical problem consists, according to the present invention, in that said method the steps consisting in:

defining at least one communication device, included in said set of terminals and corresponding to at least one subscriber to at least one service platform,

receiving via said communication device at least one control message, originating from said platform, in order to check an execution of at least one application based on at least one script, included in said control message,

transmitting via said communication device at least one identifier of said application to be executed to at least one management device, associated with said set of terminals, based on said script,

recognizing said application based on at least one list of applications stored by said management device,

recognizing at least one of said terminals of said set based on at least one list of referenced terminals stored by said management device,

checking by said management device the execution of said application for said recognized terminal of said set.

According to the invention, said set of terminals is predefined by a manager entity of said set.

Therefore, the method according to the invention allows the reception of at least one control message. A script, included in said control message, allows the checking of at least one application executed from one of the terminals of the predefined set, said execution check having been transmitted by a control message to a given communication device of said set. The terminals of the set are of any type (fixed or mobile telephones, personal computers or PCs, laptop computers, personal digital assistants or PDAs, television sets, etc.) predefined by a manager entity of the set of terminals.

According to the invention, said manager entity of said set of terminals selects an execution of said application by one of said terminals of said set.

According to the invention, a selection message is transmitted by said management device in order to select an execution of said application by one of said terminals of said set.

A selection message may allow the manager entity a choice between several terminals of said set, for example, in the case of a particular use or else when several terminals of said set may execute the application controlled based on said script.

As soon as one of said terminals is started up, the service platform detects the presence of said terminal for the handling of a transmission to said terminal, for example based on the transmission of instantaneous messages (such as Instant Messaging). In this manner, the list of terminals present and accessible may be updated in real time and checked before said selection message is transmitted.

The invention also relates to a system of communication via at least one control message for at least one predefined set of terminals, characterized in that said system comprises at least one communication device, included in said set of terminals and corresponding to at least one subscriber to at least one service platform, capable of receiving at least one control message, transmitted by said platform, in order to check an execution of at least one application based on at least one script, included in said control message, and executed by one of said terminals of said set by means of at least one management device, associated with said set of terminals

A communication device allows the identification of the terminals of said set and a list of the applications that can be accessed by each of said identified terminals to be placed in memory by a management device associated with said set of terminals.

To execute an application, based on a script included in a received control message, the management device recognizes the application and the appropriate terminal in order to execute said application thanks to the lists placed in memory.

The description that follows with respect to the appended drawing, given as a nonlimiting example, will clearly explain what is involved in the invention and how it can be embodied.

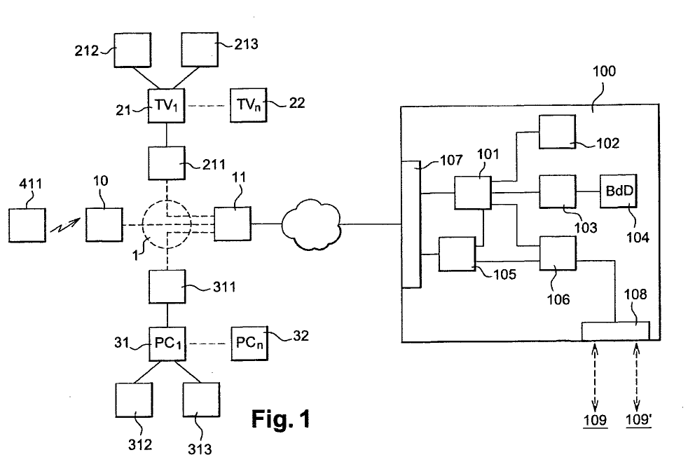

FIG. 1 represents the general architecture of a communication system based on at least one control message for at least one predefined set of terminals, according to the invention.

As FIG. 1 shows, the set of said terminals 10, 21, 22, 31, 32 of said communication system forms a local network 1 that may be, for example, a home network whose users are the members of one and the same family, or else an associative network, etc. This network, or set, is associated with at least one management device 11 that is connected to at least one communication interface 107 of a service platform 100 allowing transmission and reception interchanges across a telecommunications network. The communication between said service platform 100 and said set of terminals may be carried out over a high bit rate cable, for example via an ADSL (Asymmetric Digital Subscriber Line) high bit rate transmission. The messages transmitted to the set of terminals are received on a particular terminal 10, called the communication device, corresponding to at least one subscriber to said service platform 10.

In the embodiment of FIG. 1, there are, particularly amongst the terminals forming said set, in addition to the communication device 10, terminals 21, 31 fitted with communication interfaces 211, 311 for transmission and reception, with a fixed link or a short range radio link such as WiFi, WiMax, Bluetooth, etc. These are in particular television sets 21, 22 or personal computers 31, 32, where necessary fitted with a microphone 212, 312 and a camera 213, 313.

Terminals (not shown) may also be laptop computers, personal digital assistants or PDAs, etc. fitted with a compatible application for communication with said communication device 10. Other terminals, fixed or mobile telephones, may be used with no interface because they are directly in fixed or mobile liaison with the communication device 10.

The set of terminals is predefined by a manager entity which may be the user/subscriber of the communication device 10 (or another element). The terminals of said set 10, 21, 22, 31, 32 are known and referenced with at least one management device 11 associated with said set of terminals. Said management device 11 transmits the references of each of the terminals of said set to at least one service platform 100. Said manager entity carries out the referencing of all the constituents of said set. For each of the terminals, the terminal type (fixed or mobile telephones, television sets 21, 22, personal computers 31, 32, etc.) is specified.

Each of the terminals of the set 10, 21, 22, 31, 32 is authenticated by a s different identification depending on the type of terminal. In particular, the communication device 10 is identified by the fixed telephone number, corresponding to a subscriber to said service platform, to which it is connected by the telecommunications operator by means of the connection cable made of copper or fiber optic pairs. A mobile terminal is for example identified by the memory card, such as a SIM (Subscriber Identity Module) card or a USIM (Universal Subscriber Identity Module) card or a UICC (UMTS IC Card) card etc., which manages the security of said terminal thanks to operator signaling messages that are transparent to the user, or else by an MSISDN (Mobile Subscriber ISDN) number of a mobile terminal. A smart card or a standardized UICC card may identify each of the referenced terminals of the set, such as a television set 21, 22, a personal computer 31, 32, etc. This memory card may be placed in the communication interface 211, 311 of the terminal.

In this manner, the type of messages compatible with each of said terminals is placed in memory, such as a voice mail, a text file, a message for an electronic mail service or e-mail, a video message, an audiovisual content, etc.

In the example described, the manager entity is the user himself, but the information may be placed in memory by the telecommunications operator or, for example, by an external manager entity responsible for the referencing of the various sets of terminals.

The complete referencing of the various terminals associated with the communication device 10 is placed in memory in at least one database 104 by the service platform 100. Said database 104 may or may not be physically included in the platform 100. Once the referencing is complete, said terminals of the set 10, 21, 22, 31, 32 are recognized by the service platform 100.

As soon as one of said terminals is started up, the platform 100 detects the presence of said terminal for handling a transmission to said terminal, for example based on the transmission of instantaneous messages (such as Instant Messaging). In this manner, the list of terminals present and accessible may be updated in real time. In this manner, the management device 11 comprises at least one means for recognizing the presence of said terminals of said set. Said management device 11 may be physically separate from or included in said communication device 10. Accordingly, certain functions may without distinction be started up by the management device 11 or by the communication device 10.

The messages transmitted by the management device 11 or communication device 10 originate from various transmitting entities that are the terminals of said set 10, 21, 22, 31, 32 or of different sets of terminals (by means of the platform 100 and of at least one communication interface 107) or else of a transmitting entity 109, 109′ outside the sets of terminals by means of at least one access interface 108 of the platform 100.

Then, the manager entity of said set 10, 21, 22, 31, 32 places in memory in said database 104, via the management device 11, a list of the applications that exist or are accessible by each of the terminals of said set, such as a video playback application, a file download application, an application for streaming content such as a film or an audiovisual program, a videophone application, etc.

Said applications may be applications that exist in the terminals of said set 10, 21, 22, 31, 32, in the management device 11 or placed in memory in the database 104 of the platform 100.

As mentioned above, the referencing of the terminals may for example be carried out by an operator as the manager entity, as may a list of the existing applications. The user, as another manager entity, may then define the particular applications or others.

The communication device 10, corresponding to at least one subscriber to at least one service platform 100, is capable of receiving at least one control message, transmitted by said platform 100, allowing the checking of the execution of at least one application based on at least one script, included in said control message. The control message allows the control of said application for the processing or the response to the information contained in said control message. The communication device 10 comprises at least one module for the processing of the control messages and the recognition of the scripts. The control messages may be detected by a syntax analysis module, such as a parser allowing the recognition of said script, and the identifiers that may be incorporated into the control messages.

All the communication devices 10 or applications compatible with said platform 100 allow access to the information placed in memory by the platform 100, such as the referencing of the terminals, the list of applications, etc. corresponding to said communication device 10.

For a creation of a control message, at least one user interface allows the information necessary for the execution of at least one application to be placed in memory. Said creation may be carried out from a communication device, from one of the terminals of a set, from a terminal fitted with at least one application compatible with a communication device 10 and/or a service platform 100.

The request to create the control message is transmitted to the service platform 100 to at least one controls module 106 and to at least one scripts module 103. A scripts module 103 identifies the control message to be created thanks to a number. From the interactive user interface, in a nonexhaustive manner, predefined questions make it possible to identify a sender of the control message, at least one intended recipient of said control message, a creation date, a lifetime of said message, if it exists, at least one application to be executed, at least one number to call to establish a communication, if it exists, etc.

A controls module 106 receives the creation request and the transmitted information. Said controls module 106 verifies said information (identifier of an intended recipient, of an application, etc.) that exists in the database 104. In particular, if an application is not recognized, the controls module 106 commands the transmission of said application or else of an address at which said application can be accessed.

Once all the verifications have been made, the information is transmitted by the controls module 106 to at least one scripts module 103, which comprises at least one means for creating at least one script based on said information. Said script consists of a descriptive character string (via a predefined grammar) describing the succession of actions to be executed. The service platform 100 has created at least one script corresponding to said request to create a control message. Said script is included in a control message transmitted by the platform 100 to the receiving terminal. At least one authentication module 105 allows the recognition of said set of terminals 10, 21 22, 31, 32 in question and of said management device 11 of said set.

Said control message may be encoded by the platform 100 for a secure transmission and an interpretation solely by the management device 11 associated with said set of terminals. In this case, a decoder is included in said management device 11 of the set of terminals 10, 21, 22, 31, 32.

On receipt of a control message, the management device 11 comprises at least one means for receiving and for recognizing at least one script included in said control message. A script may be simple or complex, concerning a single application to be executed or several applications to be executed successively, provided for a synchronous execution as soon as the control message and the script are received or else provided for an asynchronous execution for example for which the execution is conditional upon the prior agreement of the intended recipient. The management device 11 comprises at least one means for recognizing and processing said descriptive character string (via a predefined grammar) describing the succession of actions to be executed.

Usually, the manager entity must accept the execution of said control message thanks to a simplified and preformatted command for said execution. The management device 11 transmits the control message to the communication device 10. For example, in the case of an invitation to participate in a debate, at least one predefined command makes it possible to accept (or refuse) to participate in the debate or in the synchronous sharing. Said predefined command allows an automatic and simplified action for the user. Then, asynchronously, when participating in the debate, a simplified command may make it possible to contribute during participation. Once the agreement has been received via the preformatted command, the management device 11 comprises at least one means for checking the execution of at least one application based on the script included in the control message.

A succession of actions may be provided: such as the invitation to complete a questionnaire; accept (or refuse) the invitation; transmit said questionnaire; complete the questionnaire; return said questionnaire.

The current execution is checked by the management device 11 in order to verify in particular that the application to be executed is recognized, that the terminal of said set 10, 21, 22, 31, 32 is present and can be accessed for the execution, etc. In the case of a negative verification, at least one error message or deferral of said execution may be transmitted to the communication device 10 of said set and/or to at least one execution checking module 101 of the platform 100.

The management device 11 and/or the service platform 100 checks the execution of said application, separately or in combination. If the platform 100 can carry out a positive check via said execution checking module 101, for example by transferring an unrecognized application to the management device 11, the execution is resumed to said set of terminals. If said verification carried out by the execution checking module 101 is again negative, the platform 100 may transmit an error message to the sender of said control message. To do this, in particular to recognize the control message number including said script and the entity sending said control message, all the information on the control messages being processed is saved by at least one archiving module 102 of the platform 100.

The control message may be an invitation to a videophone meeting with a friend or with a doctor or else between several work colleagues. After agreement to the meeting, the communication will be directed to one of the terminals fitted with at least one microphone 212, 312 and a camera 213, 313 for a videophone transmission. The management device 11, having placed the list and existing equipment for each of the terminals of said set in memory, establishes the communication to a terminal of said set that is compatible with a videophone link.

Said control message includes a script which allows the transmission of at least one identifier of the application to be executed. The management device 11 comprises at least one means for recognizing said application from the list of applications placed in memory. Said management device 11 also comprises at least one means for subsequently recognizing at least one of said terminals of said set 10, 21, 22, 31, 32 from the list of referenced terminals, placed in memory, which can execute said application or else the selected terminal. The management device 11 comprises at least one means for checking the execution of said application on said recognized terminal of said set, that is to say the control of the videophone application by one of the terminals of said set 10, 21, 22, 31, 32. The management device 11 will also control the establishment of a call between the recognized terminal and the entity sending the invitation to the videophone meeting or else to the entity participating in said meeting if it is different from the sender. In this case, said script of the control message comprises a call number to said sending entity or the participating entity, said management device 11 controlling the transmission of said call and the establishment of the communication which may or may not be via the platform 100.

Consequently, the script of a control message comprises all the information necessary to the use of at least one application corresponding to the action (or actions) provided by said message.

The management device 11 may transmit to the communication device 10 a selection message for a choice between several terminals of said set 10, 21, 22, 31, 32 that have the possibility of executing said application. In this case, the presence and accessibility of said terminals are checked before the transmission of said selection message.

The management device 11 places in memory all the information concerning the current communications, and the information for the execution of said application for a monitoring of the service provided, up to the end of use of the application and the end of the established communications. The management device 11 may comprise at least one memory, but said memory may be situated in one of the terminals of said set, for example in a memory disk of one of the personal computers (or PCs) 31, 32 of said set of terminals.

Said information is also transmitted to the service platform 100 for an archiving module 102 and placed in memory in said database 104. A placing in memory is controlled by the creation of a control message by the controls module 106, then the creation of a script by the scripts module 103, included in said control message and up to the end message originating from the management device 11 concerned.

The execution of the script is checked by the management device 11 of said set of terminals 10, 21, 22, 31, 32. In the event of an error or anomaly for the execution of said application, the management device 11 transmits a message to the execution checking module 101 to the platform 100.

When the execution of the application (or applications) is finished, the management device 11 transmits an end message to the platform 100 and the execution checking module 101, and to the archiving module 102, which may place in memory the creation and the end of the control message so as to allow statistics for the services provided. If the script included in said control message provides therefor, an end message may be transmitted to the sending entity by means of at least one access interface 108, in particular when said sending entity is not one of the terminals of said set that has executed said application or else when said sending entity has not participated in the debate, in the sharing etc.

The control message may be an invitation to a sharing around the broadcasting of an audiovisual content such as a film. In the same manner, after agreement for the sharing, the management device 11 checks the broadcasting of the audiovisual content on one of the terminals of said set, for example one of the television sets 21, 22, fitted with a microphone 212 for the simultaneous establishment of a voice communication. The management device 11, having placed the list and the existing equipment for each of the terminals of said set 10, 21, 22, 31, 32, in memory, establishes the communication to a terminal of said set that is compatible with a broadcasting of an audiovisual content.

The control message allows the identification of the application to be executed. The management device 11 recognizes said application from the list of applications placed in memory and at least one of said terminals of said set from the list of referenced terminals 10, 21, 22, 31, 32, placed in memory, that can execute said application. The management device 11 checks the execution of said application on said recognized terminal of said set. In this case, said script of the control message comprises the call number or the address on which said audiovisual content is accessible, and the call number for the voice communication.

Said control message may be an invitation to make an appointment with a sending entity 109, 109′, for example a doctor or an ANPE employment agency etc. The management device 11 controls the establishment of a communication with a database of the sending entity 109, 109′, whose address is included in said control message. The diary of the sending entity may then be transmitted for example to the screen of a personal computer 31, 32 of said set of terminals.

Said control message may also be a request to download data to an entity sending said control message, for example, a call is established with a control center for sleep disorders and the readings taken and stored via a bracelet, worn during the previous night, are transmitted to an address included in said script of the control message.

According to the invention, the service platform 100 is therefore responsible for the following functionalities, taken separately or in combination:

comparison between at least one application identifier received via a control message and those placed in memory in at least one database 104,

nondeclarative and automatic authentication, without intervention of the user, of all the terminals and their referenced users, for example on fixed connection via copper pairs, on mobile connection via SIM cards or MSISDN numbers, UICC cards, etc. by means of an authentication module 105,

reception of at least one request to create a control message, for example to a controls module 106 by means of an access interface 108,

real time monitoring of the communications, presences, control messages, scripts.

In particular, said service platform 100 also allows the functions, taken separately or in combination:

organization and administration of the sets of referenced terminals by a manager entity via a communication interface 107,

identification of at least one communication device 10, included in at least one set of referenced terminals 10, 21, 22, 31, 32 and corresponding to at least one subscriber to said service platform 100,

placing in memory in said database 104 of the terminal identification tables, for identifying the applications,

creation and checking of at least one script, for example by means of a scripts module 103 and of an execution checking module 101,

saving of the services provided for statistics or verification by means of an archiving module 102.

According to the invention, the main functions of a management device 11, associated with at least one set of terminals 10, 21, 22, 31, 32 and using the system and the method of FIG. 1, taken separately or in combination, are:

administration and driving of each of the terminals of said referenced set 10, 21, 22, 31, 32 via a manager entity, with use of the checking of the execution of at least one application based on at least one script, included in at least one control message,

reception of at least one control message, originating from the platform 100, and recognition of at least one script included in said control message,

recognition of at least one application to be executed and at least one terminal of said set that is compatible with said application,

checking of the execution of said application after checking the presence and accessibility of one of the compatible terminals of said set 10, 21, 22, 31, 32.

The communication device 10 is fitted with a user interface allowing a viewing and at least one audio broadcasting means for transmission and reception.

According to the invention, the communication device 10, using the system and the method of FIG. 1, performs the following functions, taken separately or in combination:

interface for access to at least one control and selection message,

processing of at least one control message and recognition of at least one script,

communication interface with the other terminals 21, 22, 31, 32 of the set and with at least one management device 11.

Said communication device 10 also allows the reception of simultaneous communications in voice or text mode and the reception of commands by manual remote control 411.

The control messages including scripts for accessing an application may be detected by a syntax analysis module, such as a parser, allowing the recognition of said script, and of the identifiers that may be incorporated in the control messages.

According to the invention, a communication method using the system of FIG. 1 comprises the steps described below, taken separately or in combination:

defining at least one communication device 10, included in said set of terminals 10, 21, 22, 31, 32 and corresponding to at least one subscriber to at least one service platform 100,

receiving via said communication device 10 at least one control message, originating from said platform 100, for controlling an execution of at least one application based on at least one script, included in said control message,

transmitting, via said communication device 10, at least one identifier of said application to be executed to at least one management device 11, associated with said set of terminals 10, 21, 22, 31, 32, based on said script,

recognizing said application from at least one list of applications placed in memory by said management device 11,

recognizing at least one of said terminals of said set based on at least one list of the referenced terminals 10, 21, 22, 31, 32, placed in memory by said management device 11,

checking by said management device 11 the execution of said application for said recognized terminal of said set.

Said received control message comprises, among other things, a script which includes at least one identifier of at least one application. The management device 11 recognizes said script and identifies the identifier of the application. Said management device 11 searches if said application exists in the list placed in memory in the memory of the management device 11 or in the database 104 by the platform 100.

When the identifier of said application is recognized in the list of applications placed in memory, the management device 11 identifies a terminal of said set 10, 21, 22, 31, 32 allowing the use of said recognized application. The management device 11 processes said control message and includes at least one item of information mentioning the identifier of said application and of at least one terminal of said recognized set 10, 21, 22, 31, 32. Said control message is then transmitted to the communication device 10.

Said processed control message allows the control of the recognized application thanks to the script and the execution of the latter by a terminal of said set. If several terminals are compatible with said application, for example several television sets 21, 22 or several personal computers 31, 32, the selection of one of the proposed terminals is possible. In this case, the presence and accessibility of said terminals is checked before said selection message is transmitted.

Said script, included in the control message, allows the control of said application, which is executed on one of said terminals of said set 10, 21, 22, 31, 32, by means of the management device 11.

When various sets of terminals are managed by a telecommunications operator, a service platform 100 may centralize the checking of the various management devices 11, by means of said telecommunications network to which said communication interface 107 is connected.

Certain functions of the management device 11 may also be performed by the service platform 100, such as for example the detection of the presence and the accessibility of the terminals of said set, or else in particular a list of the existing applications for said terminals in order to transmit an unlisted application to be controlled by a control message.

When the management device 11 does not recognize the identifier of the application in the list of the applications placed in memory, said management device 11 establishes a communication to the service platform 100. The service platform 100 has placed in memory the applications referenced by the various manager entities, and the applications identified in the control messages received. By default, the platform 100 establishes a communication to the sending entity 109, 109′ of the control message received in order to access said application. The method also includes a step of controlling said service platform 100 in order to transmit the applications to be executed to the management device 11.

1. A method for communicating messages by at least one control message for at least one predefined set of terminals (10, 21, 22, 31, 32), wherein said method comprises the steps:
defining at least one communication device (10), included in said set of terminals (10, 21, 22, 31, 32) and corresponding to at least one subscriber to at least one service platform (100);
receiving via said communication device (10) at least one control message, originating from said platform (100), in order to check an execution of at least one application based on at least one script, included in said control message;
transmitting via said communication device (10) at least one identifier of said application to be executed to at least one management device (11), associated with said set of terminals (10, 21, 22, 31, 32), based on said script;
recognizing said application based on at least one list of applications stored by said management device (11);
recognizing at least one of said terminals of said set from at least one list of referenced terminals (10, 21, 22, 31, 32) stored by said management device (11); and
checking by said management device (11) the execution of said application for said recognized terminal of said set.

2. The method as claimed in claim 1, wherein a selection message is transmitted by said management device (11) in order to select an execution of said application by one of said terminals of said set (10, 21, 22, 31, 32).

3. The method as claimed in claim 1, wherein the presence of said terminals of said set (10, 21, 22, 31, 32) is recognized by said management device (11).

4. The method as claimed in claim 1, wherein said method comprises a step for creating at least one script included in said control message by at least one service platform (100).

5. The method as claimed in claim 1, wherein said method comprises a step of checking the execution of said application, separately or in combination, by said management device (11) via said service platform (100).

6. The method as claimed in claim 1, wherein said method comprises a step for controlling said service platform (100) in order to transmit at least one application to be executed.

7. The method as claimed in claim 1, wherein at least one manager entity of said set of terminals selects an execution of said application by one of said terminals of said set (10, 21, 22, 31, 22).

8. The method as claimed in claim 1, wherein said set of terminals (10, 21, 22, 31, 32) is predefined by said manager entity of said set.

9. A system for communicating messages via at least one control message for at least one predefined set of terminals (10, 21, 22, 31, 32), wherein said system comprises at least one communication device (10), included in said set of terminals (10, 21, 22, 31, 32) and corresponding to at least one subscriber to at least one service platform (100), capable of receiving at least one control message, transmitted by said platform (100), in order to check an execution of at least one application based on at least one script, included in said control message, and executed by one of said terminals of said set (10, 21, 22, 31, 32) by means of at least one management device (11), associated with said set of terminals (10, 21, 22, 31, 32).

10. The system as claimed in claim 9, wherein said management device (11) comprises means for receiving and for recognizing at least one script, included in said control message, and for checking the execution of at least one application based on said received script.

11. The system as claimed in claim 9, wherein said management device (11) comprises means for recognizing at least one application to be executed and at least one of said referenced terminals of said set (10, 21, 22, 31, 32) for executing said application.

12. The system as claimed in claim 9, wherein said management device (11) comprises means for recognizing the presence of said terminals of said set.

13. A platform for using the method as claimed in claim 1 and including a system for communicating messages via at least one control message for at least one predefined set of terminals (10, 21, 22, 31, 32), wherein said system comprises at least one communication device (10), included in said set of terminals (10, 21, 22, 31, 32) and corresponding to at least one subscriber to at least one service platform (100), capable of receiving at least one control message, transmitted by said platform (100), in order to check an execution of at least one application based on at least one script, included in said control message, and executed by one of said terminals of said set (10, 21, 22, 31, 32) by means of at least one management device (11), associated with said set of terminals (10, 21, 22, 31, 32);
wherein said platform (100) carries out the following functionalities, taken separately or in combination:
(a) comparison between at least one identifier of an application received via a control message and those placed in memory in at least one database (104),
(b) nondeclarative and automatic authentication of all the terminals and their referenced users,
(c) reception of at least one request to create a control message, and
(d) real time monitoring of the communications, presences, control messages, scripts.

14. A management device for using the method according to claim 1 and including a system for communicating messages via at least one control message for at least one predefined set of terminals (10, 21, 22, 31, 32), wherein said system comprises at least one communication device (10), included in said set of terminals (10, 21, 22, 31, 32) and corresponding to at least one subscriber to at least one service platform (100), capable of receiving at least one control message, transmitted by said platform (100), in order to check an execution of at least one application based on at least one script, included in said control message, and executed by one of said terminals of said set (10, 21, 22, 31, 32) by means of at least one management device (11), associated with said set of terminals (10, 21, 22, 31, 32);
wherein said management device (11) carries out the following functionalities, taken separately or in combination:
(a) administration and driving of each of the terminals of said set (10, 21, 22, 31, 32) referenced by a manager entity, with use of the checking of the execution of at least one application based on at least one script, included in at least one control message,
(b) reception of at least one control message, originating from the platform (100), and recognizing at least one script included in said control message,
(c) recognition of at least one application to be executed and at least one terminal of said set that is compatible with said application, and
(d) checking of the execution of said application after checking the presence and accessibility of one of the compatible terminals of said set (10, 21, 22, 31, 32).

15. A communication device for using the method as claimed in claim 1 and including a system for communicating messages via at least one control message for at least one predefined set of terminals (10, 21, 22, 31, 32), wherein said system comprises at least one communication device (10), included in said set of terminals (10, 21, 22, 31, 32) and corresponding to at least one subscriber to at least one service platform (100), capable of receiving at least one control message, transmitted by said platform (100), in order to check an execution of at least one application based on at least one script, included in said control message, and executed by one of said terminals of said set (10, 21, 22, 31, 32) by means of at least one management device (11), associated with said set of terminals (10, 21, 22, 31, 32);
wherein said communication device (10) carries out the following functionalities, taken separately or in combination:
(a) interface for access to at least one control and selection message,
(b) processing of at least one control and recognition message of at least one script, and
(c) communication interface with the other terminals (21, 22, 31, 32) of the set and with at least one management device (11).
